(19) United States
(12) Patent Application Publication
(10) Pub. No.: US 2004/0254659 A1
(43) Pub. Date: Dec. 16, 2004

(54) Playlist radio

(76) Inventors: Mark Bolas, Mountain View, CA (US); Ian McDowall, Woodside, CA (US)

Correspondence Address: Mark Bolas, 2326 Jewell Place, Mountain View, CA, 94043, US

(21) Appl. No.: 10/222,355

(22) Filed: Aug. 16, 2002

Related U.S. Application Data
(60) Provisional application No. 60/313,771, filed on Aug. 20, 2001.

(51) Int. Cl. G06F 17/00

(52) U.S. Cl. 700/94

(57) ABSTRACT

A playlist creation system which uses playlists from broadcasting radio stations and other information to create a new custom playlist which uses songs available to a user's device. The new custom playlist recreates the musical mood of the radio station on which the playlist was based biased by user specific preferences.

### CROSS REFERENCE TO RELATED APPLICATIONS

This application is Provisional Application:

No.: 60/313,771

Filed: Aug. 20, 2001

Name of Applicant: Mark Bolas

Title: Playlist Radio

This application was not a result of federally funded R&D

### BACKGROUND OF THE INVENTION

The consumer market is purchasing an increasing number of devices that have the capability to record and playback a vast amount of music and other recorded sound. For example, Creative Laboratories offers a product called the Nomad Jukebox which can digitally record the equivalent of well over 50 albums of music. This represents over 500 different individual songs, or roughly 500 hours of unique audio content.

With such a vast amount of content available to the consumer, a new need is being felt—how to assist the consumer in deciding what to record, what to play, and when to play it.

In some ways the problem is similar to that faced by a user in front of a jukebox that has an atypically large selection. The user must figure out what songs he would like to hear, and in what order to place those songs. Such a listing of songs is commonly referred to as a playlist. Users of modern personal music recording and playback devices (called a digital walkman in this description), such as the Nomad Jukebox described above, have problems that go beyond that of the barroom jukebox. They must also decide on what songs to add to the jukebox, figure out how to actually pay for and or add the songs to the jukebox, and must typically accomplish these tasks with a very simple user interface that usually consists of a few lines of text and does not include the artwork associated with the song or the album. Note that the selection of a good playlist must take into consideration songs available; ordering of the songs desired; and the specific mood and desires of the listener or listeners which typically change over time.

Clearly, the consumer has a need for a better solution.

There is a source of compelling playlists that are popular and desired by the public at large. These are lists of songs that are played by radio stations. Radio stations face portions of the same problem as the user of a digital walkman. They must choose which records to add to their vast library of music, and must choose and find a compelling sequence of songs. Additionally, Radio stations must pick playlists that meet an expectation of the listener—that is to say that listeners expect a certain type of playlist of specific radio stations at specific times. The radio station must fulfill this mood expectation with a compelling playlist.

### BRIEF SUMMARY OF THE INVENTION

This invention describes a system, which augments the functionality of a digital walkman to allow user to interact with and control the digital walkman, in a manner that is similar to listening to listening to a sequence of songs as if they were played on the radio, or chosen by a friend. In addition to providing the user with a simple interface for listening to sequences of audio selections, this invention can also assist the user in selecting and recording (or downloading) audio content not yet located on the user's digital walkman.

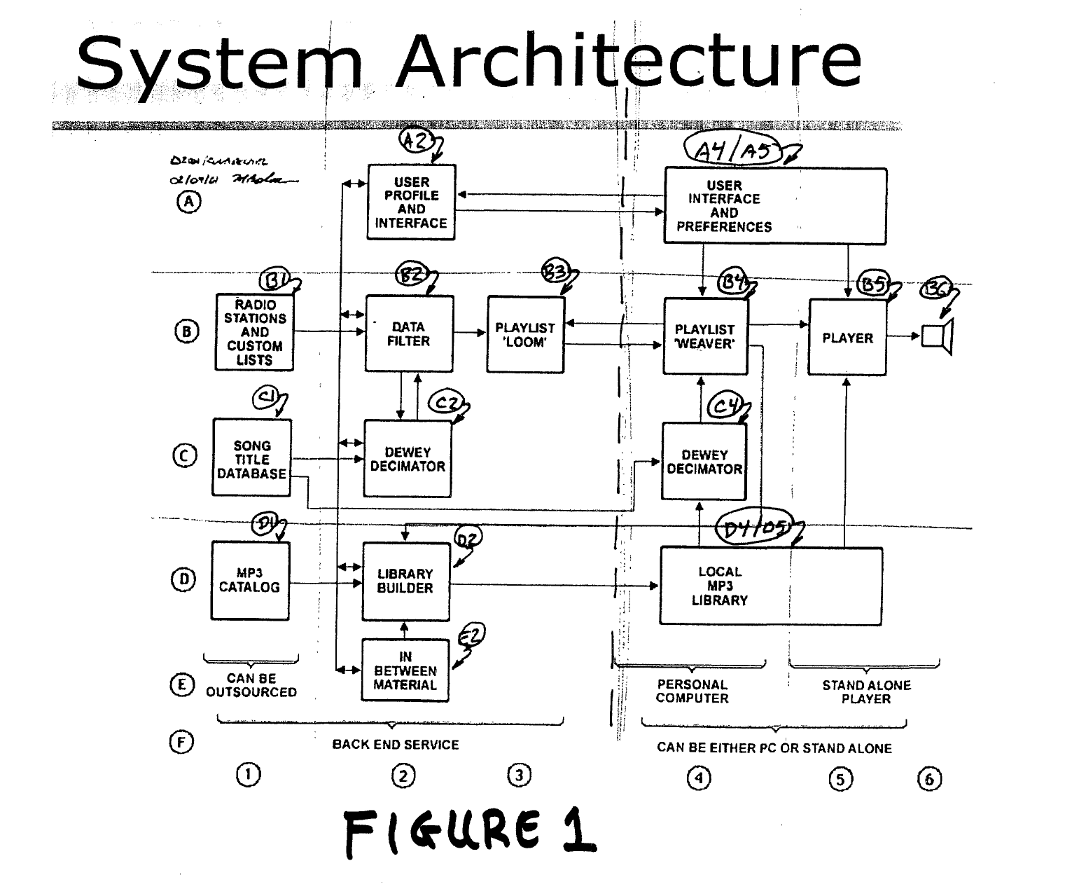

Please refer to FIG. 1.

B6 is the speaker or headphones that a user uses to listen to the audio material.

B5 is called the ‘player’. This is hardware and software that is used to convert digital content, typically stored on hard disk or other record able medium, into an electrical signal that can be played as sound by the speaker B6. There are many hardware and software products that can accomplish this task. These products can be located on a personally computer (for example a Winamp like product) or they can be located in a standalone player (for example the player that is shipped with the Nomad Jukebox).

D4 and D5 is the local content library of audio content. Note that it can be located on either a personal computer, a standalone player or both. This library of content is encoded in any number of standards—currently it is typically encoded as a standard known as MP3. The player (B5) must be capable of decoding whatever encoding scheme has been used, and multiple schemes may be used.

A4 and A5 represent a library of user preferences, and a human machine interface (such as a keyboard and perhaps a simple display) which enable the user to input preferences and control the personal computer and/or the standalone device, and are located on either the personal computer and/or the standalone device.

C4 is software which associates a unique identifier with a specific song located on D4 and is called the Dewey Decimator. Because identical songs can have similar but different titles associated with them, C4 chooses a single identifier for each unique song. C4. The Dewey Decimator can receive updated database information and algorithms to accomplish this task from an offline Song Title Database C1.

B4 is the Playlist Weaver. B4 analyses data from a number of sources to determine the best list of songs to play based upon songs that are currently available in the Local Library D4/D5; playlist associations from the Playlist Loom (B3); user input and existing preferences stored or input from A4/A5. The Weaver outputs which song to play or a list of songs to play to the Player B5, and can optionally output a list of songs to a Library Builder D2 that will update the Local Library D4/D5 at an appropriate time.

The Playlist Loom B3 analyses sets of playlists that are associated with a given category, for example a radio station's call letters and time of day (other examples include a genre or specific Disk Jockey or a band , etc.). The Loom then analysis the songs in the playlists, and crates playlist associations that are used by the Playlist Weaver B4. These associations can include, for example, a value given for specific pairs of songs. If song A is typically played in conjunction with Song B, but song A is rarely played in conjunction with Song C, then the Loom will give the song pair AB a high value but the song pair AC a low value. In this way, the Weaver B4 will be more likely to play song B in conjunction with Song A and not Song C. The user can begin a playlist, for example, by asking the Weaver to play a particular song, and then to follow that song with the next best song in the library and to continue in this fashion for 10 songs. This is just one example of the type of logic the Loom/Weaver combination can use. Another example is the Loom can feeds the Weaver a list of the last 10 playlists associated with a given radio station. The Weaver analyses songs stored in the Local Library D4/D5 and chooses the list that has the most songs available in the Local Library. In this fashion, a user can listen to music that is similar to a radio station that the user is already familiar to listing to.

It is useful to note that the Loom B3 has typically analyzed playlists from a number of sources before passing data to the Weaver. This analysis can be associated with a specific radio station, or DJ, etc. The user interface A2 works in conjunction with the user interface A4/A5 to assure a correlation between the user's expectations and the Loom/Weaver's analysis and choices. The user interface A2 can be located on an offline server website (not the ‘playing device’ that is either a personal computer, or standalone device, or both).

The Loom requires a Data Filter B2 which collects and formats playlists with important associated data (such as radio station, or time of day, or DJ, etc.); and which correlates these playlists to a unique song identifier from an Offline Dewey Decimator C2 which is similar in function to the Dewey Decimator C4. Finally, the Data Filter formats the appropriate User Profile and Input Data A2 before passing all of this formatted data to the Loom.

While not specifically required by the above, a Library Builder D2 can greatly increase the user's enjoyment of this system, and provide a logical place to charge the user for the audio content. The Playlist Weaver B4 reports to the Library Builder which songs were not available in the local MP3 library, and can also report a weight that indicates how important that song was to complete a playlist. For example, in the example given above, if the Library does not have song B, and the Weaver chooses song C, then the Weaver can indicate to the Library Builder that the Local Library needs song B. The Builder D2 is expected to work with an existing catalog of available audio content and such content could be purchased on a case-by-case basis or as part of a subscription or such content could be made available but only with an associated advertisement that is provided via the In Between Material E2. E2 can also provide audio content that is specific to a time of day, such as a traffic report, or a radio station, such as DJ comments regarding songs.

B1 represents a myriad of available playlists. These can be culled from existing radio stations via companies that make such data available for purchase, from playlist title information available on streaming internet radio stations, from custom lists provided by list sharing services such as Uplister, etc.

In the preferred embodiment the Player B5 is a stand-alone player that is fed standard M3U play lists. For example the player is the Winamp program. In the preferred embodiment, sections 4 and 5 of the block diagram are completely operated on a personal computer, and not in a stand-alone device. The personal computer should be a ‘Wintel’ compatible computer of the type typically in use—for example a Windows 98 operating system coupled to an Intel Pentium computer with typical hard disk, display, interface, etc. Computer needs to have a connection to the internet that preferably operates at a rate of 1.25 Mbit/second or higher, that which is typical of a home with DSL service and a DSL modem and interface card.

In the preferred embodiment the Dewey decimator is not required as the local MP3 library has uniquely identifying names associated with the songs. This is controlled by the Music Service Provider (MSP) so that the names are controlled and thus unique. It is expected that the user's PC already have a collection of MP3 content, or that the user downloads such content beforehand. In the Preferred Embodiment, content is downloaded from a providers such as Napster or MP3.com.

In the preferred embodiment, the user's PC and system is all elements that are above the numbers 4 and 5 in the diagram. All elements in the diagram above numbers 1, 2, and 3 are the responsibility of the MSU.

In the preferred embodiment the user interface is a text file that the user can edit with a standard text editor such as WordPad. This file contains a single line which is a four character word which corresponds to the call-letters of the radio station the user would like the generated M3U files to sounds like. This four-character word must correspond with an available station provided by the MSU.

In operation of the preferred embodiment, the Weaver B4 reads the text file of User Preferences A4, and then communicates with the Loom B4 to request data from which the Weaver will create a play list that corresponds to the desired 4-character preference in the User Preferences file.

The Loom communicates a file corresponding to the desired radio station which consists of a 10 music sequence lists of 10 song titles that are filtered to be unique to songs provided for download at a different time onto the user's PC by the MSU. The Weaver then determines which songs contained in the 10 music sequence lists of songs are currently contained on the users local MP3 library D4/D5. The Weaver then creates a standard M3U file that corresponds to the single music sequence list that contains the most song titles that are also on the user's PC. If two or more music sequence lists have the same number of songs on the PC then the Weaver randomly selects one of the lists. The M3U file that is created by the Weaver is the same as the single music sequence list communicated to the Weaver by the Loom, except that the Weaver has deleted songs, which are not on the local MP3 library. The Weaver keeps track of the MP3 library before this process by scanning the users disk for any files of the MP3 type, and then keeping a list of those files in the Dewey Decimator file C4 one of the lists. The M3U file that is created by the Weaver is the same as the single music sequence list communicated to the Weaver by the Loom, except that the Weaver has deleted songs, which are not on the local MP3 library. The Weaver keeps track of the MP3 library before this process by scanning the users disk for any files of the MP3 type, and then keeping a list of those files in the Dewey Decimator file C4. Note that for this preferred embodiment, the Dewey Decimator is not required to determine unique songs as that has been accomplished by only having the user download songs that have unique titles as provided by the MSP. Note further that the Weaver creates a list of songs that were in the list provided by the Loom, but not located on the PC as MP3 files with standard titles. This list is communicated back to the MSP's library builder file D2. The user is then sent an e-mail with this list of songs at a later time with internet links to a location that the user can purchase and download the music from D1. In the preferred embodiment this is accomplished with standard commercial offerings currently available on the internet.

With the playlist created by the Weaver as an M3U file, the user then directs the Player program, for example Winamp, to play the M3U file.

In the preferred embodiment, the MSP receives a text file from a radio station that contains 10 music sequence lists of 10 song titles that are typical of that station's play lists. The MSP (or back-end service) formats these song titles for transmission to the loom as a simple text file. In formatting this list, the titles are checked to make sure they are unique to the songs provided by the MP3 Catalog D1. In the preferred embodiment this takes place manually, however the Dewey Decimator is shown in the diagram should it take place automatically.

In the preferred embodiment the user's preference station stored in the text file A4 is communicated to the MSP via standard internet protocols every time the Weaver requests data from the Loom. The MSP can use this data to effect library choices, and play lists stored. In the preferred embodiment the In Between Material E2 function is not used.

We claim:

1. A playlist creating system comprising:
access to a library of available songs;
access to radio station playlists;
creating a new playlist through analyzing said radio station playlists and said song library.
